(19) United States
(12) Patent Application Publication
(10) Pub. No.: US 2025/0022234 A1
(43) Pub. Date: Jan. 16, 2025

(54) DISPERSION COMPENSATION IN DIFFRACTIVE AUGMENTED REALITY SYSTEMS

(71) Applicant: Applied Materials, Inc., Santa Clara, CA (US)

(72) Inventors: Evan WANG, Palo Alto, CA (US); David Alexander SELL, Santa Clara, CA (US); Kunal SHASTRI, Santa Clara, CA (US); Sihui HE, Santa Clara, CA (US); Kevin MESSER, Mountain View, CA (US); Samarth BHARGAVA, Saratoga, CA (US)

(21) Appl. No.: 18/769,595

(22) Filed: Jul. 11, 2024

Related U.S. Application Data
(60) Provisional application No. 63/526,563, filed on Jul. 13, 2023.

(51) Int. Cl. G06T 19/00; G02B 5/04; G02B 6/10; G02B 27/01

(52) U.S. Cl. CPC G06T 19/006; G02B 5/04; G02B 6/10; G02B 27/0172

(57) ABSTRACT

The present disclosure relates to augmented reality devices and related methods. In one or more embodiments, an augmented reality device includes a projection system and a waveguide. The projection system includes a projector and a prism. The projector projects an image along the projectors major axis. The prism refracts the image having a first spectrum, a second spectrum, and a third spectrum. The waveguide is disposed at a wrap angle from a plane formed from the major axis of the projector. The waveguide includes an input coupler and an output coupler. The input coupler includes input structures at an input period and an input orientation and the input coupler is configured to receive the spectrums at different corresponding input angles. The output coupler includes output structures at an output period and an output orientation and the output coupler out couples the respective spectrums at an about equal output angle.

### CROSS-REFERENCE TO RELATED APPLICATIONS

This application claims priority to U.S. Provisional Patent Application Ser. No. 63/526,563 filed on Jul. 13, 2023, which is herein incorporated by reference in its entirety.

### BACKGROUND

### Field

Embodiments of the present disclosure generally relate to waveguides and augmented reality devices having projections systems and waveguides.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality. Accordingly, what is needed in the art are augmented reality devices with projections systems and waveguides.

### SUMMARY

The present disclosure relates to augmented reality devices and related methods. In one or more embodiments, an augmented reality device includes a projection system and a waveguide. The projection system includes a projector and a prism. The projector projects an image along the projectors major axis. The prism refracts the image having a first spectrum, a second spectrum, and a third spectrum. The waveguide is disposed at a wrap angle from a plane formed from the major axis of the projector. The waveguide includes an input coupler and an output coupler. The input coupler includes input structures at an input period and an input orientation and the input coupler is configured to receive the spectrums at different corresponding input angles. The output coupler includes output structures at an output period and an output orientation and the output coupler out couples the respective spectrums at an about equal output angle.

In one or more embodiments augmented reality device is provided. The augmented reality device includes a frame arm coupled to a frame, a projection system, and a waveguide. The projection system is disposed in the frame arm. The projection system includes a projector with a major axis and configured to project an image along the major axis. The projection system also includes a prism configured to refract the image. The image includes a first spectrum, a second spectrum, and a third spectrum. The waveguide is coupled to the frame arm and disposed at a wrap angle from a plane formed from the major axis of the projector. The waveguide includes an input coupler having input structures disposed at an input period and an input orientation and an output coupler having output structures disposed at an output period and an output orientation.

In one or more embodiments augmented reality device is provided. The augmented reality device includes a projection system and a waveguide. The projection system includes a projector and a prism. The projector has a major axis and is configured to project an image along the major axis. The prism is configured to refract the image. The image includes a first spectrum, a second spectrum, and a third spectrum. The waveguide is disposed at a wrap angle from a plane formed from the major axis of the projector. The waveguide includes an input coupler having input structures disposed at an input period and an input orientation, a pupil expander having pupil structures disposed at a pupil period and an pupil orientation, and an output coupler having output structures disposed at an output period and an output orientation.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments.

FIG. 1A is a schematic, top view of an augmented reality device, according to embodiments described herein.

FIG. 1B schematic cross-sectional view a portion of the augmented reality device in FIG. 1A, according to embodiments described herein.

FIG. 2A is schematic, top view of a waveguide according to embodiments described herein.

FIG. 2B is a k-space diagram of the waveguide in FIG. 2A, according to embodiments described herein.

FIG. 3A is schematic, top view of a waveguide according to embodiments described herein.

FIG. 3B is a k-space diagram corresponding to the waveguide in FIG. 3A, according to embodiments described herein.

FIG. 3C is a schematic, top view of the input coupler of the waveguide in FIG. 3A, according to some embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguides for augmented, mixed, or virtual reality. Specifically, embodiments described herein provide for an optical system for use with augmented reality (AR) where a user can see through the display lenses of the glasses or other head-mounted display device to view the surrounding environment, and see images of virtual objects that are generated for display and appear as part of the environment. A prism can be placed along the light path between the projector and the waveguide. Angling the projector at a projector tilt angle causes the optical system to lose ergonomics. Similarly, the use a prism alone causes the light to refract along the light path, reducing image quality. Complex prisms are capable of minimizing dispersion but increase manufacturing costs. Embodiments of the present disclosure relate to the combination of a prism and diffractive waveguide to minimize image blur, maintain ergonomics, and reduce manufacturing costs.

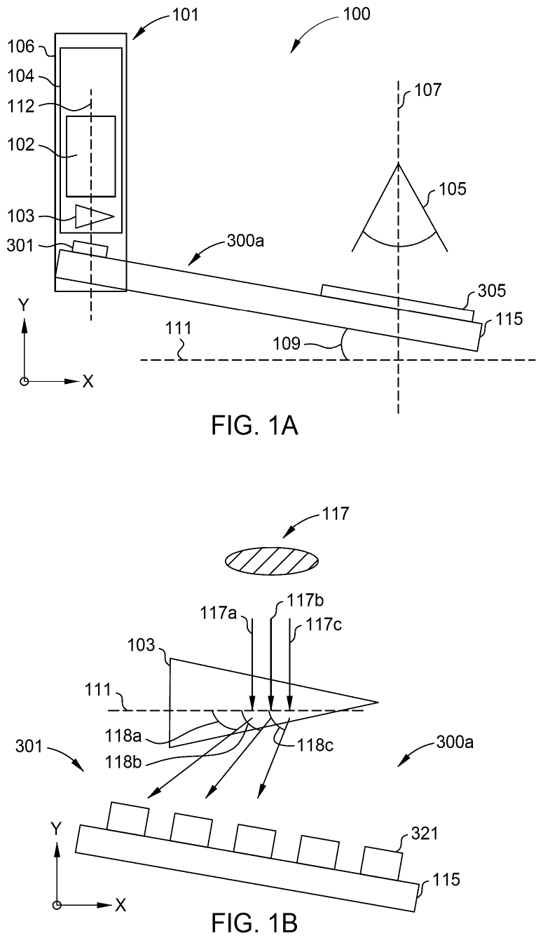

FIG. 1A is a schematic, top view of an augmented reality device 100. FIG. 1B is a schematic cross-sectional view a portion of the augmented reality device 100 in operation. The device 100 includes a projection system 101 and a waveguide 300a. The projection system 101 includes a projector 102 and a prism 103. The projector 102 is coupled to a frame arm 104. The frame arm 104 is coupled to a frame 106. The frame 106 retains the waveguide 300a and couples the waveguide 300a to the frame arm 104. The waveguide 300a is disposed at a wrap angle 109. A plane 111 is perpendicular to a major axis 112 of the projector 102. The plane 111 is formed having the major axis 112 as the normal vector to the plane 111. The device 100 includes a wrap angle 109 between the plane 111 and the waveguide 300a. The wrap angle 109 is about −10° to about 30°. For example, the wrap angle 109 is about 1° to about 10°. In some embodiments, the major axis 112 of the projector 102 is about parallel to an eye axis 107 of the user's eye 105. In some embodiments, the major axis 112 of the projector 102 is angled about −10° to about 30° from the eye axis 107 of the user's eye 105.

It is desirable for the projector 102 to be aligned within the frame arm 104 while the waveguide 300a is disposed at the wrap angle 109 for improvements in ergonomics, reduced weight, and reduced device 100 size. The projector 102 and the prism 103 are disposed in the frame arm 104 such that the major axis 112 of the projector 102 is aligned with the frame arm 104. The prism 103 is configured to refract an image 117 from the projector 102 towards the waveguide 300a. The prism 103 allows the projector 102 to be disposed in the frame arm 104 instead of angled inward toward a user's temple while still accounting for the wrap angle 109. This orientation allows for a reduction in width of the frame arm 104 of the frame 106, providing enhanced ergonomics. The projector 102 and prism 103 operating in conjunction with the waveguide 300a enables less complexity in the manufacturing of the prism 103 due to the waveguide 300a mitigating dispersion from the prism 103.

The projector 102 is operable to project the image 117 that include includes a first spectrum 117a, a second spectrum 117b, and a third spectrum 117c of light. In some embodiments, the first spectrum 117a corresponds to blue light, the second spectrum 117b corresponds to green light, and the third spectrum 117c corresponds to red light. The prism 103 of the projection system 101 enables the image 117 to be in-coupled by the waveguide 300a. In operation, the first spectrum 117a, the second spectrum 117b, and the third spectrum 117c (hereinafter the “spectrums 117a, 117b, 117c”) are refracted by the prism 103 before entering the input coupler 301 disposed at the wrap angle 109. As seen in FIG. 1B, the first spectrum 117a, the second spectrum 117b, and the third spectrum 117c enter the input coupler 301 at a corresponding first input angle 118a, second input angle 118b, and third input angle 118c (hereinafter the “input angles 118a 118b, 118c”). As the image 117 passes through the prism 103, different wavelengths of light bend and change speed as they travel between mediums with different refractive indexes. For example, when light travels from a lower refractive index to a higher refractive index, the light angles away from the normal vector. The wavelength of the light determines the degree at which the light angles away from the normal vector.

The prism 103 bends the image 117 from the projector 102 towards the input coupler 301 to account for the wrap angle 109. The prism 103 refracts the image 117 such that each of the spectrums 117a, 117b, 117c travel through the prism 103 at different rates and leave the prism 103 at different angles. The variations between the spectrums 117a, 117b, 117c cause the spectrums 117a, 117b, 117c to enter the input coupler at different input angles 118a 118b, 118c. In some embodiments, the prism 103 is a triangular chromatic prism of a single material. In some embodiments, the prism 103 is a doublet prism of two-materials, but other higher order prisms are contemplated.

In a head-mounted display (HMD) that incorporates the device 100, disposing the waveguide 300a at the wrap angle 109 and aligning the major axis 112 of the projector 102 along the frame arm 104 improves usability of the device 100. Usability is improved by improving the comfort and reducing the size of a HMD while maintaining a clear image 117 received by the eye 105. The device 100 incorporates the prism 103 to allow the projector 102 to be parallel with the frame arm 104. The waveguide 300a compensates for any dispersion and refraction of the prism 103 such that the k-vector of the waveguide 300a corresponds to a k-vector of the prism 103. The waveguide 300a compensates for the prism 103 by diffracting the first spectrum 117a, the second spectrum 117b, and the third spectrum 117c such that the first spectrum 117a, the second spectrum 117b, and the third spectrum 117c travel to the user's eye 105 at the same angle from the output coupler 305.

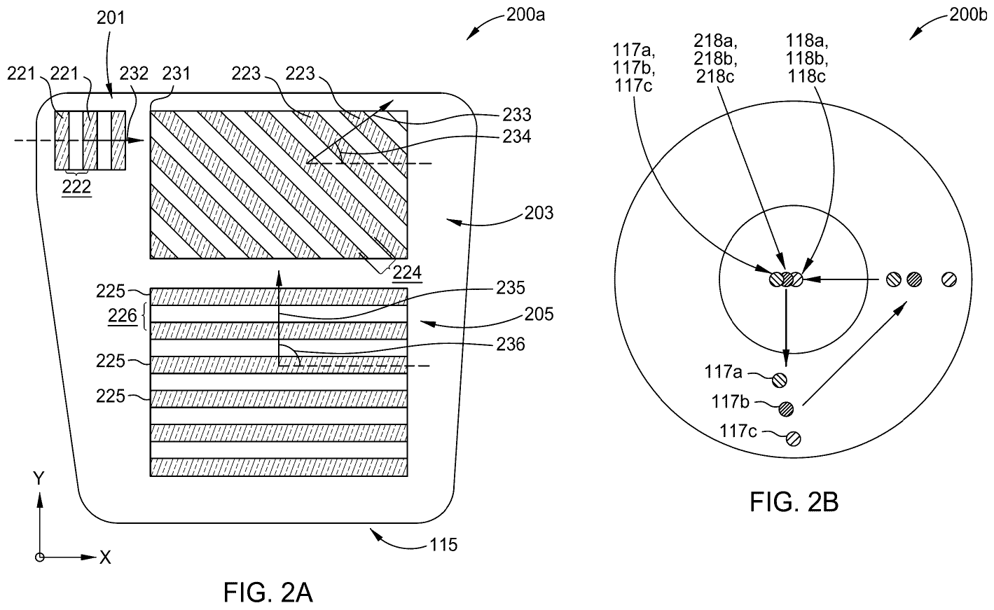

FIG. 2A is a schematic, top view of a waveguide 200a. The waveguide 200a is an uncompensated waveguide. I.e., the waveguide 200a does not compensate for the refractive dispersion of prism 103 such that the change in the k-vector through the waveguide 200a is 0. FIG. 2B is a k-space diagram 200b of the waveguide 200a. The waveguide 200a includes an input coupler 201, a pupil expander 203, and an output coupler 205 disposed on the substrate 115.

The input coupler 201 includes input structures 221. The input structures 221 have an input period 222 and an input orientation 232. The input period 222 is the distance between the midpoints of adjacent input structures 221. In some embodiments, the input period 222 is defined as the distance between the leading edge of adjacent input structures 221. The input period 222 is the same when measuring between the mid points or leading edge of adjacent input structures 221. The input period 222 is about 10 nanometers (nm) to about 200 nm. As shown in FIG. 2A, the input coupler 201 of the waveguide 200a has an input orientation 232 defined as the angle between the x-axis and a normal vector 231 of the input structures 221. Without compensation, the normal vector 231 is aligned with the input orientation 232 in the waveguide 200a. As shown, the input orientation 232 is along the x-axis with an input orientation being 0°.

The pupil expander 203 includes pupil structures 223. The pupil structures 223 have a pupil period 224 and a pupil orientation 234. The pupil period 224 is the distance between the midpoints of adjacent pupil structures 223. In some embodiments, the pupil period 224 is defined as the distance between the leading edge of adjacent pupil structures 223. The pupil period 224 is the same when measuring between the mid points or leading edge of adjacent pupil structures 223. The pupil period 224 is about 10 nanometers (nm) to about 200 nm. As shown in FIG. 2A, the pupil expander 203 of the waveguide 200a has a pupil orientation 234 defined by the angle between the x-axis and a normal vector 233 of the pupil structures 223. The pupil orientation 234 is about 90°.

The output coupler 205 includes output structures 225. The output structures 225 have an output period 226 and an output orientation 236. The output period 226 is the distance between the midpoints of adjacent output structures 225. In some embodiments, the output period 226 is defined as the distance between the leading edge of adjacent output structures 225. The output period 226 is the same when measuring between the mid points or leading edge of adjacent output structures 225. The output period 226 is about 10 nanometers (nm) to about 200 nm. As shown in FIG. 2A, the output coupler 205 of the waveguide 200a has an output orientation 236 defined by the angle between the x-axis and a normal vector 235 of the output structures 225.

As the first spectrum 117a, the second spectrum 117b, and the third spectrum 117c enter the input coupler 201 at a corresponding first input angle 118a, second input angle 118b, and third input angle 118c (the input angles 118a, 118b, 118c), the spectrums 117a, 117b, 117c undergo total internal reflection (TIR) within the waveguide 200a. As illustrated by a k-space diagram 200b in FIG. 2B, the projector 102 projects an image 117 having the first spectrum 117a, the second spectrum 117b, and the third spectrum 117c (hereinafter the “spectrums 117a, 117b, 117c”). The image 117 is diffracted by the prism 103 such that the spectrums 117a, 117b, 117c have input angles 118a, 118b, 118c that are different from each other at the input coupler 201. I.e., the spectrums 117a, 117b, 117c have corresponding input angles 118a, 118b, 118c that spread the spectrums 117a, 117b, 117c across the input coupler 201.

The first spectrum 117a, the second spectrum 117b, and the third spectrum 117c leave the output coupler 205 at a corresponding first output angle 218a, second output angle 218b, and third output angle 218c. The first output angle 218a, second output angle 218b, and third output angle 218c (the output angles 218a, 218b, 218c) are different from one another. Because the spectrums 117a, 117b, 117c leave the output coupler 205 at different output angles 218a, 218b, 218c, the image 117 is blurry and lacks definition. I.e. the output angles 218a, 218b, 218c spread the spectrums 117a, 117b, 117c across the user's eye 105. The waveguide 200a has a minimal change in the k-vector of an image passing through the waveguide. Thus, the image 117 being dispersed into the first spectrum 117a, the second spectrum 117b, and the third spectrum 117c enters and leaves the waveguide 200a as a dispersed image that would appear blurry and lacking clarity.

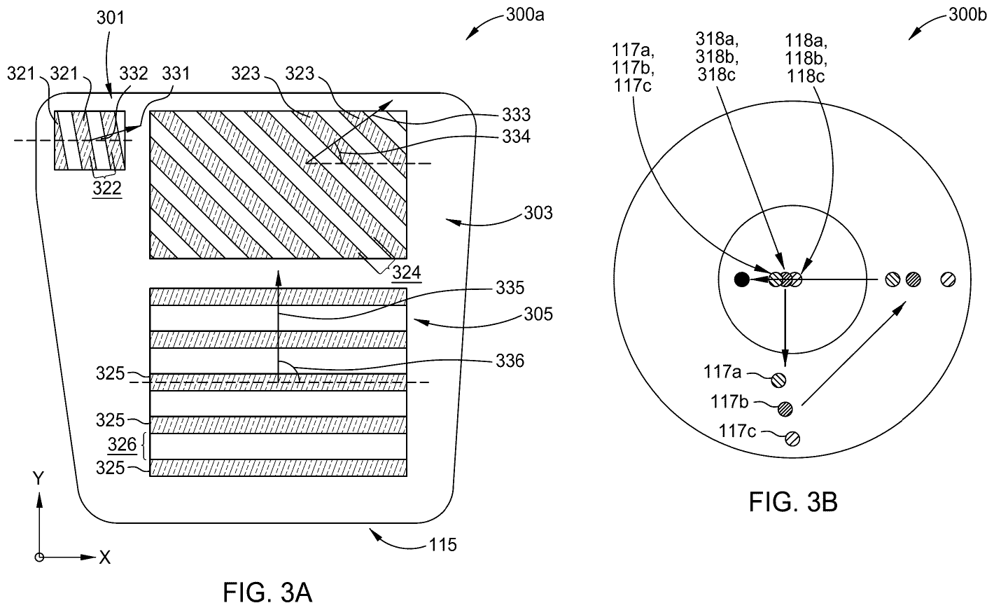

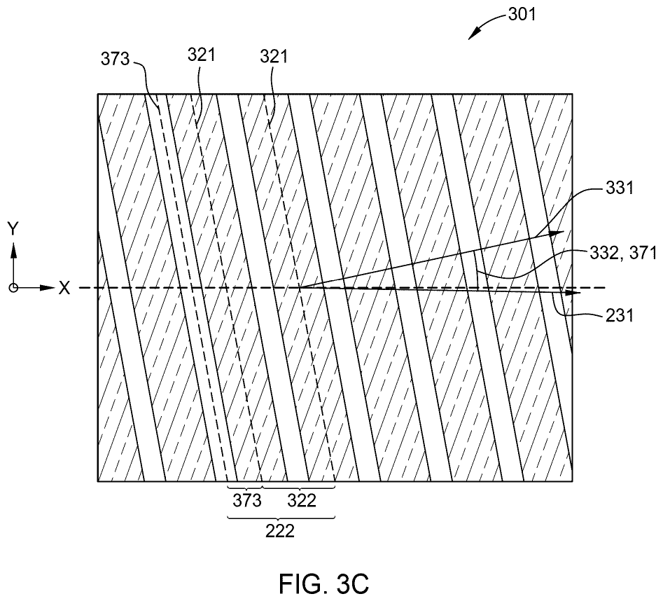

FIG. 3A is a schematic, top view of a waveguide 300a. The waveguide 300a is a compensated waveguide. The waveguide 300a compensates for the refractive dispersion of prism 103 such that the change in the k-vector through the waveguide 300a is a non-zero value. I.e. the change in the k-vector is greater than or less than 0. FIG. 3B is k-space diagram 300b of the waveguide 300a. The waveguide 300a as further described herein includes an architecture of the input coupler 301, a pupil expander 303, and the output coupler 305 such that the first spectrum 117a, the second spectrum 117b, and the third spectrum 117c leave the output coupler 305 at a corresponding first output angle 318a, second output angle 318b, and third output angle 318c. The first output angle 318a, second output angle 318b, and third output angle 318c (the output angles 318a, 318b, 318c) are about the same as one another while the input angles 118a, 118b, 118c are different. The waveguide 300a compensates for the different input angles 118a, 118b, 118c to produce an image 350 at an about uniform angle that is sharp when viewed by the eye 105. The waveguide 300a includes a k-vector. The k-vector of the waveguide 300a is a non-zero vector and is the inverse of the k-vector of the prism 103 (FIG. 1A). The waveguide 300a compensates for the prism 103 by diffracting the image 117 corresponding to the refractive dispersion of the prism 103.

The input coupler 301, the pupil expander 303, and the output coupler 305 are each disposed on the substrate 115. The substrate 115 may include substrates of any suitable material, including, but not limited to, amorphous dielectrics, non-amorphous dielectrics, crystalline dielectrics, silicon-containing materials, polymers, and combinations thereof. In one embodiment, which can be combined with other embodiments described herein, the substrate 115 includes one or more of silicon (Si), silicon dioxide (SiO₂), silicon carbide (SiC), fused silica, diamond, or quartz materials. In some embodiment, which can be combined with other embodiments described herein, the substrate 115 includes of one or more of nitrogen, titanium, niobium, lanthanum, zirconium, or yttrium containing-materials. The substrate 115 may include optical material having a refractive index of about 2, e.g., about 1.7 to 2.3, about 1.8 to 2.2, about 1.9 to 2.1, or about 2.0 to 2.1.

The input coupler 301 includes input structures 321. The input structures 321 have an input period 322 and an input orientation 332. The input period 322 is the distance between the midpoints of adjacent input structures 321. In some embodiments, the input period 322 is defined as the distance between the leading edge of adjacent input structures 321. The input period 322 is the same when measuring between the mid points or leading edge of adjacent input structures 321. The input period 322 is about 10 nanometers (nm) to about 300 nm. The input period 322 is different from the input period 222. As shown in FIG. 3A, the input coupler 301 of the waveguide 300a has an input orientation 332 defined by the angle between the x-axis and a normal vector 331 of the input structures 321. The input orientation 332 is greater than 0°. In some embodiments, the input coupler 301 component of the k-vector for the waveguide 300a compensates for the dispersion of the prism 103 by adjusting the input period 322 and the input orientation 332. I.e., the prism 103 refracts the image 117 by a first k-vector and the k-vector component corresponding to the input coupler 301 is configured to diffract the image 117, the input coupler 301 k-vector component being inverse of the prism 103 k-vector.

The pupil expander 303 includes pupil structures 323. The pupil structures 323 have a pupil period 324 and a pupil orientation 334. The pupil period 324 is the distance between the midpoints of adjacent pupil structures 323. In some embodiments, the pupil period 324 is defined as the distance between the leading edge of adjacent pupil structures 323. The pupil period 324 is the same when measuring between the mid points or leading edges of adjacent pupil structures 323. The pupil period 324 is about 10 nanometers (nm) to about 300 nm. As shown in FIG. 3A, the pupil expander 303 of the waveguide 300a has a pupil orientation 334 defined by the angle between the x-axis and a normal vector 333 of the pupil structures 323. The pupil orientation 334 is greater than or less than 45°.

The output coupler 305 includes output structures 325. The output structures 325 have an output period 326 and an output orientation 336. The output period 326 is the distance between the midpoints of adjacent output structures 325. In some embodiments, the output period 326 is defined as the distance between the leading edge of adjacent output structures 325. The output period 326 is the same when measuring between the mid points or leading edges of adjacent output structures 325. The output period 326 is about 10 nanometers (nm) to about 300 nm. The output orientation 336 is defined as the angle between the x-axis and a normal vector 335 of the output structures 325. The output orientation 336 is greater or less than 90°.

As the first spectrum 117a, the second spectrum 117b, and the third spectrum 117c enter the input coupler 301 at a corresponding first input angle 118a, second input angle 118b, and third input angle 118c (the input angles 118a, 118b, 118c), the spectrums 117a, 117b, 117c undergo total internal reflection (TIR) within the waveguide 300a. As illustrated by a k-space diagram 300b in FIG. 3B, the projector 102 is configured to project the image 117 having the spectrums 117a, 117b, 117c dispersed by the prism 103 into the input coupler 301 at different input angles 118a, 118b, 118c. The first spectrum 117a, the second spectrum 117b, and the third spectrum 117c leave the output coupler 305 at a corresponding first output angle 318a, second output angle 318b, and third output angle 318c (the output angles 318a, 318b, 318c). In contrast to the k-space diagram 200b, the output angles 318a, 318b, 318c are about the same and produce an image 350 that is clear.

In some embodiments, the different wavelengths of the first spectrum 117a enter the input coupler 301 as a first incidence cone at the first input angle 118a with the different wavelengths of the first spectrum 117a forming an apex angle of the first incidence cone. The different wavelengths of the second spectrum 117b enter the input coupler 301 as a second incidence cone at the second input angle 118b with the different wavelengths of the second spectrum 117b forming an apex angle of the second incidence cone. The different wavelengths of the third spectrum 117c enter the input coupler 301 as a third incidence cone at the third input angle 118c with the different wavelengths forming an apex angle of the third incidence cone. The waveguide 300a aligns the centers of the cones from the different input angles 118a 118b, 118c to about the same angle, and further reduces the apex angles of each of the first incidence cone of the first spectrum 117a, the second incidence cone of the second spectrum 117b, and the third incidence cone of the third spectrum 117c, thereby aligning the wavelengths within each spectrum closer to their respective the output angles 318a, 318b, 318c.

The waveguide 300a compensates for the prism 103 by adjusting at least one or more of the input period 322, the input orientation 332, the pupil period 324, the pupil orientation 334, the output period 326 and the output orientation 336, such that the k-space diagram 300b has a non-zero k-vector. I.e. the k-vector of the waveguide 300a is the inverse k-vector of the prism 103. The k-vector of the prism 103 is a normalized k-vector across multiple wavelengths of light. The k-vector of the waveguide 300a is the inverse of the normalized k-vector of the prism 103. The waveguide 300a uses diffractive gratings to counter the refractive dispersion of the prism 103. Using the waveguide 300a to compensate for the prism 103 enhances the ultimate image quality and reduces costs associated with more complex prisms.

FIG. 3C is a schematic, top view of the input coupler 301 of the waveguide 300a, according to some embodiments. The input coupler 301 has a different input period 322 and input orientation 332 than the waveguide 200a. The input coupler 301 diffracts the spectrums 117a, 117b, 117c to compensate for the refractive dispersion from the prism 103.

The input orientation 332 of the input structures 321 have been changed from the input orientation 232 of input structures 221 in the input coupler 201 of waveguide 200a (FIG. 2A). The input orientation 332 has been changed by a compensation angle 371. The compensation angle 371 is the change in normal vector 231 of the waveguide 200a to the normal vector 331 of the waveguide 300a. The compensation angle 371 is about 1 arcsec to about 5°.

While the compensation angle 371 is shown for the input coupler 301, changes illustrated by a new normal vector 333 of the pupil expander 303 and changes illustrated by a new normal vector 335 of the output coupler 305 are also represented by compensation angles of about 1 arcsec to about 5° when compared to the waveguide 200a (FIG. 2A).

The k-vector (\vec{k}₀) is calculated using the following equation:

$${\vec{k}}_{0} = \frac{2 π}{{Λ}_{0}} [ cos {θ}_{0} , sin {θ}_{0} ]$$

Where θ₀ is the orientation of the input coupler 201 in the waveguide 200a and Λ₀ is the input period 222.

The k-vector (\vec{k}_{comp}) of the waveguide 300a includes compensation Δ\vec{k}. The compensation Δ\vec{k} includes the change in grating periodicity ΔΛ and orientation Δθ from the uncompensated waveguide 200a (\vec{k}₀). The k-vector (\vec{k}_{comp}) of the waveguide 300a is calculated using the following equation:

$${\vec{k}}_{c o m p} = {\vec{k}}_{0} + Δ \vec{k} = \frac{2 π}{{Λ}_{0} + Δ Λ} [ cos ( {θ}_{0} + Δ θ ) , sin ( {θ}_{0} + Δ θ ) ]$$

In the context of the input coupler 201 and input coupler 301, the compensation angle 371 is Δθ, the input orientation 232 is θ₀, and the input orientation 332 is θ₀+Δθ in the above equation. The compensation angle 371 is about 0.002° to about 0.005°, for example, about 0.003°. The change in the input orientation 332 allows light to diffract the spectrums 117a, 117b, 117c when traveling through the waveguide 300a toward the pupil expander 303 (FIG. 3A). To compensate for the refraction of the prism 103, the input orientation 232 is changed by the compensation angle 371.

The periodicity of the grating structures 321 has been changed from the input period 222 (Λ₀) of the input coupler 201 of the waveguide 200a (FIG. 2A) to the input period 322 of the input coupler 301 of the waveguide 300a (FIG. 3A) by a compensation delta 373 (ΔΛ). The compensation delta 373 is defined as the change in the input period 222 of the waveguide 200a and input period 322 of the waveguide 300a. The input period 322 is the input period 222 plus the compensation delta 373. The input period 322 corresponds to (Λ₀+ΔΛ) in the above equation. The compensation delta 373 is about 0.001 nanometers to about 1 nanometers (nm). While the input coupler 301 of the waveguide 300a is shown, the compensation delta 373 can also be applied to the pupil expander 303, the output coupler 305, or a combination of the input coupler 301, the pupil expander 303, and the output coupler 305.

The device 100 described herein includes improved usability by improving the comfort and reducing the size of a HMD while maintaining image clarity seen by a user's eye. The device 100 incorporates the prism 103 to allow the projector 102 to be aligned within the frame arm 104, and the combination of the prism 103 and waveguide 300a further enables weight savings. The waveguide 300a compensates for any dispersion and refraction caused by the prism 103, allowing the image to enter the waveguide 300a as different spectrums at different input angles, but the different spectrums leave the waveguide 300a at about the same output angle. By compensating for dispersion with the waveguide 300a, costs of expensive complex prisms can be reduced.

While the foregoing is directed to embodiments of the disclosure, other and further embodiments may be devised without departing from the basic scope thereof, and the scope thereof is determined by the claims that follow.

What is claimed is:

1. An augmented reality device comprising:
a projection system comprising:
a projector comprising a major axis, the projector configured to project an image along the major axis; and
a prism configured to refract the image, the image comprising a first spectrum, a second spectrum, and a third spectrum; and
a waveguide disposed at a wrap angle from a plane formed from the major axis of the projector, the waveguide comprising:
an input coupler having input structures disposed at an input period and an input orientation, the input coupler configured to receive the first spectrum, the second spectrum, and the third spectrum at different angles; and
an output coupler having output structures disposed at an output period and an output orientation, the output coupler operable to out couple the first spectrum at a first output angle, the second spectrum at a second output angle, and the third spectrum at a third output angle, wherein the first output angle is about equal to the second output angle, the second output angle is about equal to the third output angle.

2. The device of claim 1, wherein the prism is a chromatic prism.

3. The device of claim 1, wherein the input coupler is disposed along the major axis.

4. The device of claim 1, wherein the prism refracts the image by a first k-vector and the input coupler is configured to diffract the image by a second k-vector, the second k-vector being inverse of the first k-vector.

5. The device of claim 1, wherein a k-vector of the waveguide is greater than 0.

6. The device of claim 1, wherein a k-vector of the waveguide corresponds to a k-vector of the prism.

7. The device of claim 1, wherein the prism is disposed along the major axis and between the projector and the waveguide.

8. The device of claim 1, wherein the input coupler is configured to receive the first spectrum at a first input angle, the second spectrum at a second input angle, and the third spectrum at a third input angle, the first input angle different from the second input angle and the third input angle, the second input angle different from the third input angle.

9. The device of claim 1, wherein the input orientation is greater than 0°.

10. The device of claim 1, wherein the output orientation is greater than or less than 90°.

11. An augmented reality device comprising:
a frame arm coupled to a frame;
a projection system disposed in the frame arm, the projection system comprising:
a projector comprising a major axis, the projector configured to project an image along the major axis; and
a prism configured to refract the image, the image comprising a first spectrum, a second spectrum, and a third spectrum; and
a waveguide coupled to the frame arm, the waveguide disposed at a wrap angle from a plane formed from the major axis of the projector, the waveguide comprising:
an input coupler having input structures disposed at an input period and an input orientation; and
an output coupler having output structures disposed at an output period and an output orientation.

12. The device of claim 11, wherein the frame arm is aligned along the major axis.

13. The device of claim 11, wherein the projector is disposed within the frame arm.

14. The device of claim 11, wherein the waveguide has a non-zero k-vector.

15. The device of claim 14, wherein the k-vector of the waveguide corresponds to a k-vector of the prism.

16. An augmented reality device comprising:
a projection system comprising:
a projector comprising a major axis, the projector configured to project an image along the major axis; and
a prism configured to refract the image, the image comprising a first spectrum, a second spectrum, and a third spectrum; and
a waveguide disposed at a wrap angle from a plane formed from the major axis of the projector, the waveguide comprising:
an input coupler having input structures disposed at an input period and an input orientation;
a pupil expander having pupil structures disposed at a pupil period and an pupil orientation; and
an output coupler having output structures disposed at an output period and an output orientation.

17. The device of claim 16, wherein the input orientation is greater than 0°, the pupil orientation is greater than 45°, or the output orientation is greater than 90°.

18. The device of claim 16, wherein a k-vector of the input coupler corresponds to a k-vector of the prism.

19. The device of claim 16, wherein a k-vector of the prism corresponds to the wrap angle.

20. The device of claim 16, wherein the prism is triangular prism of a single material.
